(19) United States
(12) Patent Application Publication
(10) Pub. No.: US 2017/0363888 A1
(43) Pub. Date: Dec. 21, 2017

(54) LIQUID CRYSTAL OPTICAL ELEMENT AND METHOD FOR MANUFACTURING SAME

(71) Applicant: PANASONIC INTELLECTUAL PROPERTY MANAGEMENT CO. LTD., Osaka (JP)

(72) Inventors: Hirofumi KUBOTA, Osaka (JP); Tomonori YAMADA, Osaka (JP)

(73) Assignee: PANASONIC INTELLECTUAL PROPERTY MANAGEMENT CO. LTD., Osaka (JP)

(21) Appl. No.: 15/541,391

(22) PCT Filed: Feb. 19, 2016
(86) PCT No.: PCT/JP2016/000902

§ 371 Date: Jul. 3, 2017

(30) Foreign Application Priority Data
Mar. 27, 2015 (JP) 2015-067367

(51) Int. Cl. G02F 1/1334; G02F 1/1343; G02F 1/1341; G02F 1/1347

(52) U.S. Cl. CPC G02F 1/1334; G02F 1/13475; G02F 1/13439; G02F 1/1341; G02F 2202/023; G02F 2202/043

(57) ABSTRACT

A liquid crystal optical element includes a first transparent body which includes a first transparent substrate, a first transparent electrode, and a projection-depression structure; a second transparent body which includes a second transparent substrate and a second transparent electrode; and a liquid-crystal-containing resin layer interposed between the first transparent body and the second transparent body. At least one of a size of a droplet of a droplet structure and a size of a mesh of a network structure in the liquid-crystal-containing resin layer is larger near the first transparent body than near the second transparent body. Alternatively, the liquid-crystal-containing resin layer has: a first region that contains the liquid crystal and does not contain the resin; and a second region that contains both the liquid crystal and the resin.

### TECHNICAL FIELD

The present disclosure relates to a liquid crystal optical element and a method for manufacturing the same. To be more specific, the present disclosure relates to a liquid crystal optical element that includes a layer containing a liquid crystal and a resin, and to a method for manufacturing the liquid crystal optical element.

### BACKGROUND ART

A liquid crystal optical element that changes between a light transmission state and a light scattering state according to the presence or absence of an electric field has been conventionally proposed. For example. Patent Literature (PTL) 1 discloses a liquid crystal display device that includes a liquid crystal layer containing a polymer dispersed liquid crystal. The liquid crystal display device disclosed in PTL 1 enhances the contrast of black and white by a configuration that changes in optical state.

However, although the liquid crystal display device disclosed in PTL 1 controls a transparent state and a scattering state by changing a liquid crystal orientation, this liquid crystal display device does not control light distribution (a change in a traveling direction of light, in particular).

### CITATION LIST

### Patent Literature

PTL 1: Japanese Unexamined Patent Application Publication No. 2005-250055

### SUMMARY OF THE INVENTION

### Technical Problem

The present disclosure has an object to provide a liquid crystal optical element that is capable of controlling light distribution and changing between a transparent state and a scattering state, and also provide a method for manufacturing the liquid crystal optical element.

### Solution to Problem

A liquid crystal optical element according to an aspect of the present disclosure includes a first transparent body, a second transparent body, and a liquid-crystal-containing resin layer. The first transparent body includes a first transparent substrate, a first transparent electrode, and a projection depression structure. The second transparent body includes a second transparent substrate and a second transparent electrode that is electrically paired with the first transparent electrode. The liquid-crystal-containing resin layer is interposed between the first transparent body and the second transparent body and acid contains a liquid crystal and a resin.

Moreover, in the liquid crystal optical element according to the aspect, the liquid-crystal-containing resin layer may have at least one of a droplet structure formed from the liquid crystal and a network structure formed from the resin, and at least one of a size of a droplet of the droplet structure and a size of a mesh of the network structure may be larger near the first transparent body than near the second transparent body.

Furthermore, in the liquid crystal optical element according to the aspect, the liquid-crystal-containing resin layer may have: a first region that contains the liquid crystal and does not contain the resin; and a second region that contains both the liquid crystal and the resin, and the first region may be closer to the first transparent body than the second region is to the first transparent body, and may cover the projection-depression structure.

Moreover, a method for manufacturing a liquid crystal optical element according to a first aspect of the present disclosure is a method for manufacturing the liquid crystal optical element described above, and includes: forming the first transparent body; forming the second transparent body; interposing, between the first transparent body and the second transparent body, a resin composition that contains a liquid crystal material, an ultraviolet curable resin, a polymerization initiator, and an ultraviolet absorber; and irradiating the resin composition with ultraviolet light through the second transparent body.

Furthermore, a method for manufacturing a liquid crystal optical element according to a second aspect of the present disclosure is a method for manufacturing the liquid crystal optical element described above and includes: forming the first transparent body; forming the second transparent body; interposing, between the first transparent body and the second transparent body, a resin composition that contains a liquid crystal material, an ultraviolet curable resin, and a polymerization initiator; and irradiating the resin composition with ultraviolet light through the second transparent body, wherein a volume ratio of the polymerization initiator in the resin composition is 0.3% or less.

Moreover, a method for manufacturing a liquid crystal optical element according to a third aspect of the present disclosure is a method for manufacturing the liquid, crystal optical element described above and includes: forming the first transparent body; forming the second transparent body; forming, on the second transparent body, a layer that contains a polymerization initiator; interposing, between the first transparent body and the second transparent body, a resin composition that contains a liquid crystal material and an ultraviolet curable resin; and irradiating the resin composition with ultraviolet light through the second transparent body.

Furthermore, a method for manufacturing a liquid crystal optical element according to a fourth aspect of the present disclosure is a method for manufacturing the liquid crystal optical element described above and includes: forming the first transparent body; forming the second transparent body; interposing, between the first transparent body and the second transparent body; a resin composition that contains a liquid crystal material, an ultraviolet curable resin, and a polymerization initiator; and irradiating the resin composition with ultraviolet light through the second transparent body, wherein the polymerization initiator is immiscible with the ultraviolet curable resin, and before the irradiating, the resin composition forms a layer that has: a region that is closer to the second transparent body and, includes the polymerization initiator; and a region that is closer to the first transparent body and includes the resin and the liquid crystal.

Moreover, a method for manufacturing a liquid crystal optical element according to a fifth aspect of the present disclosure is a method for manufacturing the liquid crystal optical element described above and includes: forming the first transparent body; forming the second transparent body; interposing, between the first transparent body and the second transparent body; a resin composition that contains a liquid crystal material, an ultraviolet curable resin, a polymerization initiator, and a radical trapping agent and irradiating the resin composition with ultraviolet light through the second transparent body.

### Advantageous Effect of Invention

According to the present disclosure, light distribution can be controlled by the projection-depression structure and the liquid-crystal-containing resin layer. Thus, the liquid crystal optical element that can change between the scattering state and the transparent state can be obtained.

### BRIEF DESCRIPTION OF DRAWINGS

FIG. 1 is a schematic cross-sectional view showing an example of a liquid crystal optical element.

FIG. 2 is a schematic cross-sectional view showing a liquid crystal optical element according to Embodiment 1.

FIG. 3A is a diagram showing an example of a network structure near a second transparent body of the liquid crystal optical element.

FIG. 3B is a diagram showing an example of a network structure near a first transparent body of the liquid crystal optical element.

FIG. 4 is a schematic perspective view showing an example of the first transparent body of the liquid crystal optical element.

FIG. 5 is a schematic cross-sectional view showing a liquid crystal optical element according to Embodiment 2.

FIG. 6 is a schematic perspective view showing an example of a first transparent body that includes a liquid crystal.

FIG. 7A is a schematic cross-sectional view showing a liquid crystal optical element according to a comparative example.

FIG. 7B is an enlarged view showing a part of FIG. 7A.

FIG. 8A is a cross-sectional view showing a first process of a method for manufacturing a liquid crystal optical element.

FIG. 8B is a cross-sectional showing a second process of the method for manufacturing the liquid crystal optical element.

FIG. 8C is a cross-sectional view showing a third process of the method for manufacturing the liquid crystal optical element.

FIG. 8D is a cross-sectional view showing a fourth process of the method fey manufacturing the liquid crystal optical element.

FIG. 8E is a cross-sectional view showing a fifth process of the method for manufacturing the liquid crystal optical element.

FIG. 9 is a cross-sectional view showing an example of a method for manufacturing a liquid crystal optical element.

### DESCRIPTION OF EXEMPLARY EMBODIMENTS

FIG. 1 is a schematic cross-sectional view showing an example of a liquid crystal optical element (liquid crystal optical element 1) according to the present disclosure.

As shown in FIG. 1, liquid crystal optical element 1 includes first transparent body 10, second transparent body 20, and liquid-crystal-containing resin layer 30. First transparent body 10 includes first transparent substrate 11, first transparent electrode 12, and projection-depression structure 13. Second transparent body 20 includes second transparent substrate 21 and second transparent electrode 22. Second transparent body 20 is disposed opposite to first transparent body 10. Second transparent electrode 22 is electrically paired with first transparent electrode 12. Liquid-crystal-containing resin layer 30 includes a liquid crystal and a resin. Liquid-crystal-containing resin layer 30 is interposed between first transparent body 10 and second transparent body 20.

Liquid crystal optical element 1 has at least one of a first mode and a second mode described below.

According o the first mode, liquid-crystal-containing resin layer 30 includes at least one of a droplet structure formed from a liquid crystal and a network structure formed from a resin. In this case, at least one of a size of a droplet of the droplet structure and a size of a mesh of the network structure is larger near first transparent body 10 than near second transparent body 20.

According to the second mode, liquid-crystal-containing resin layer 30 includes the following: a first region that contains the liquid crystal and does not contain the resin; and a second region that contains both the liquid crystal and the resin. In this case, the first region is closer to first transparent body 10 than the second region is to first transparent body 10. Moreover, the first region covers projection-depression structure 13,

Liquid crystal optical element 1 shown in FIG. 1 includes the first mode and the second mode.

Liquid crystal optical element 1 according to the present disclosure can control light distribution by projection-depression structure 13 and liquid-crystal-containing resin layer 30, in both the first mode and the second mode. With this, liquid crystal optical element 1 can change between the scattering state and the transparent state. In addition, liquid crystal optical element 1 has high control characteristics for light distribution, and a difference between the scattering state and the transparent state is significant. The reason for this is as follows. Since a region near projection-depression structure 13 has a high presence rate of the liquid crystal and a low presence rate of the resin, light scattering that results from a refractive index difference between the liquid crystal and the resin at an interface between projection-depression structure 13 and liquid-crystal-containing resin layer 30 is suppressed. Thus, light distribution is performed efficiently, and this is believed to be the reason. Here, assume that light scattering occurs at the aforementioned interface. In this case, a wavefront of light incident from projection-depression structure 13 to liquid-crystal-containing resin layer 30 is distorted. As a result, light distribution does not occur because light refraction according to Huygens' principle does not occur. Hence, liquid crystal optical element 1 having high optical characteristics can be obtained according to the present disclosure.

Furthermore, liquid-crystal-containing resin layer 30 may contain a dichroic dye. With this, when a voltage is not applied to liquid crystal optical element 1 (i.e., an OFF state), liquid crystal optical element 1 is colored. Then, when a voltage is applied to liquid crystal optical element 1 an ON state), liquid crystal optical element 1 becomes transparent. Here, when a black dichroic dye is used, light is absorbed by the dichroic dye and outside light is thereby blocked. Thus, incident light can be blocked by liquid crystal optical element 1 without using a curtain or a dow shade. This enhances a design quality of a window. As the dichroic dye, an azo dye or an anthraquinone dye indicated by a molecular structure below can be used for example.

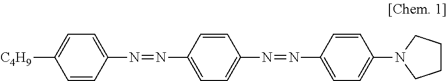

For example, assume that liquid-crystal-containing resin layer 30 contains about 0.1% to 1% of dichroic dye with respect to the liquid. crystal. In this case, a transmittance of liquid crystal optical element 1 is reduced to 5% or less, and thus the effect of light blocking can be obtained.

Liquid crystal optical element 1 is switched between the transparent state and the scattering state by the application of a voltage. When a voltage is applied, liquid crystal molecules are all oriented in a direction of an electric field. As a result, light that passes through liquid crystal optical element 1 travels in a uniform direction. Thus, liquid crystal optical element 1 is brought into the transparent state. On the other hand, when no voltage is applied, the liquid crystal molecules are oriented in different directions in liquid-crystal-containing resin layer 30. As a result, light that passes through liquid crystal optical element 1 travels in various directions and is scattered. Thus, liquid crystal optical element 1 is brought into the scattering state. Moreover, a refractive index of liquid-crystal-containing resin layer 30 of liquid crystal optical element 1 may be changed by the application of voltage, and may match with a refractive index of projection-depression structure 13. Here, when the refractive indexes match with each other, this means that these refractive indexes are almost equal to each other. When the refractive indexes match with each other, there is no interface causing a refractive index difference. This enhances the transparency of liquid crystal optical element 1. On the other hand, assume that no voltage is applied and thus the refractive indexes do not match with each other. In this case, the refractive index difference between the resin of projection-depression structure 13 and the liquid crystal of liquid-crystal-containing resin layer 30 is large at the interface. This makes it easier for the light distribution performance of projection-depression structure to be exerted. By the application of voltage, continuous orientation may be caused in which the orientation of the liquid crystal molecules is maintained for a fixed period of time.

Since liquid crystal optical element 1 in the transparent state allows light to pass through liquid crystal optical element 1, an object on the opposite side can be visually identified through liquid crystal optical element 1. On the other hand, since liquid crystal optical element 1 in the scattering state causes light to be scattered, it is hard for an object on the opposite side to be visually identified through liquid crystal optical element 1. The object viewed through liquid crystal optical element 1 in the scattering state may appear blurred. Liquid crystal optical element 1 in the scattering state can be like opaque glass.

Light distribution of liquid crystal optical element 1 can be achieved by projection-depression structure 13. Light from the outside enters liquid crystal optical element 1 through first transparent body 1. Projection-depression structure 13 of liquid crystal optical element 1 changes the traveling direction of the light by projections and depressions of projection-depression structure 13. In particular, when the refractive index difference between liquid-crystal-containing resin layer 30 and projection-depression structure 13 is larger, the light is deflected by refraction and thus a degree of light distribution is also larger as compared to the case of straight light.

As shown in FIG. 1, projection-depression structure 13 is disposed on first transparent electrode 12. Projection-depression structure 13 includes a plurality of projections 131 and a plurality of depressions 132. Each bottom of projections 131 is in contact with first transparent electrode 12. Projection 131 projects toward second transparent body 20. Projection 131 is a triangle in cross section. Depression 132 is interposed between projections 131 that are adjacent to each other. Depression 132 is a space between projections 131 that are adjacent to each other. In FIG. 1, first transparent electrode 12 is in contact with liquid-crystal-containing resin layer 30 at a position where depression 132 is disposed. Projection-depression structure 13 may have an electrical conductivity. This electrical conductivity can prevent first transparent electrode 12 from being electrically interfered with, and a voltage can be thereby efficiently applied to liquid-crystal-containing resin layer 30.

Projection-depression structure 13 shown in FIG. 1 is merely an example, and the projection-depression structure is not limited to this example. For example, the bottoms of the plurality of projections may be connected together to form one layer. In this case, the depressions are depressed portions formed in the layer, and thus first transparent electrode 12 and liquid-crystal-containing resin layer 30 are not in contact with each other. Alternatively, projection-depression structure 13 may be a part of first transparent electrode 12. In this case, first transparent electrode 12 includes projection-depression structure 13, and thus has the plurality of projections and the plurality of depressions. Or, projection-depression structure 13 may he interposed between first transparent electrode 12 and first transparent substrate 11. In this case, projection-depression structure 13 provides projections and depressions to first transparent electrode 12 in a manner that an first electrode interface between transparent 12 and liquid-crystal-containing resin layer 30 has projections and depressions. In fact, an interface between liquid-crystal-containing resin layer 30 and first transparent body 10 may have projections and depressions for light distribution.

As shown in FIG. 1, liquid-crystal-containing resin layer 30 includes resin portion 31 and liquid crystal portion 32. Resin portion 31 of liquid-crystal-containing resin layer 30 is a portion in which the resin exists. Liquid crystal portion 32 of liquid-crystal-containing resin layer 30 is a portion in which the liquid crystal exists. Liquid crystal portion 32 includes a plurality of droplets 320. Droplet 320 may also be referred to as a liquid crystal droplet.

It is preferable for liquid-crystal-containing resin layer 30 to be formed from a polymer-dispersed liquid crystal or a polymer network liquid crystal. With this, high light distribution performance can be obtained. In the polymer-dispersed liquid crystal, high polymers form a resin and a liquid crystal exists in a matrix of the high polymers. In the polymer network liquid crystal, a resin exists in the form of a network and a liquid crystal exists in meshes of the network.

FIG. 1 is a schematic diagram showing that liquid-crystal-containing resin layer 30 includes a droplet structure formed from the liquid crystal, and that a size of droplet 320 of the droplet structure is larger near first transparent body 10 than near second transparent body 20 (see droplet 320a and droplet 320b). Here, since FIG. 1 is a schematic diagram, only eight droplets 320 are illustrated. Note that, however, liquid-crystal-containing resin layer 30 includes a large number of droplets 320 in practice. The size of droplet 320 decreases with distance from first transparent body 10.

FIG. 1 is a diagram showing that liquid-crystal-containing resin layer 30 includes the network structure formed from the resin, and that the mesh size of the network structure is larger near first transparent body 10 than near second transparent body 20. The resin is disposed in spaces among the plurality of droplets 320. These resins crosslink with each other to form the network structure. It can also be said that the liquid crystal is disposed in the meshes of the network structure formed from the resin. On this account when droplet 320 is larger, the mesh size of the network structure formed from the resin is also larger. Thus, it can be understood from FIG. 1 that the mesh size of the network structure is larger near first transparent body 10.

It is preferable for at least one of droplet 320 of the droplet structure and the mesh of the network structure to have, near first transparent body 10, a size that corresponds to a width of depression 132 of the projection-depression structure. With this, light distribution performance is enhanced. The reason for this is described as follows.

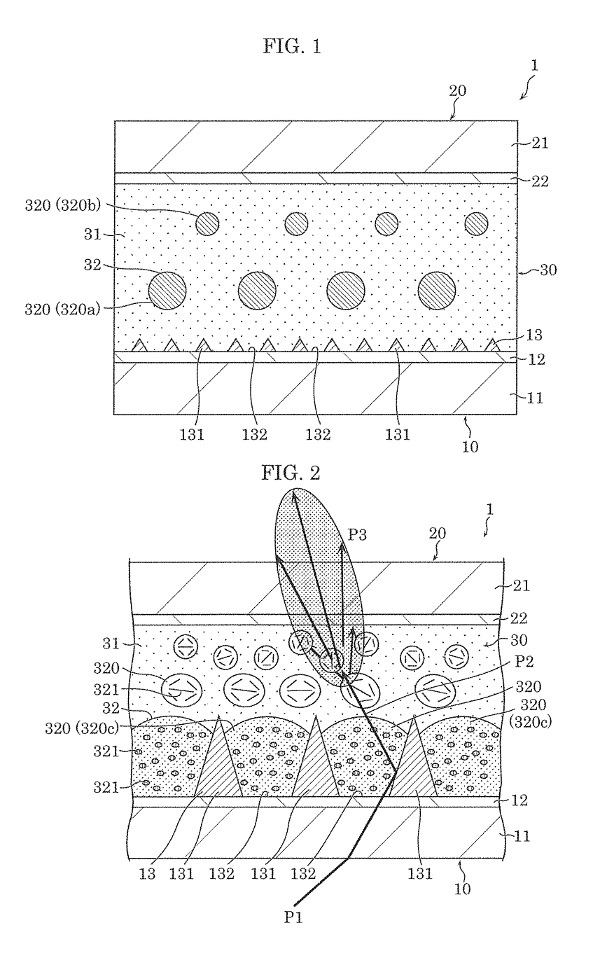

FIG. 2 is a schematic cross-sectional view showing liquid crystal optical element 1 according to Embodiment 1.

Liquid crystal optical element 1 shown in FIG. 2 is a specific example of liquid crystal optical element 1 in the first mode that is described above and shown in FIG. 1. FIG. 2 allows a function of liquid crystal optical element 1 to be understood. Structural elements in FIG. 2 that are identical to those in FIG. 1 are given the same reference numerals as in FIG. 1.

In FIG. 2, a droplet structure formed from a liquid crystal is illustrated. The droplet structure includes a plurality of droplets 320. Droplet 320 includes liquid crystal substance 321. Liquid crystal substance 321 can be a liquid crystal molecule. Here, in FIG. 2, liquid crystal substance 321 in droplet 320 that is in contact with projection-depression structure 13 is illustrated as an ellipse, and liquid crystal substance 321 in droplet 320 that is not in contact with projection-depression structure 13 is illustrated as a line. The diagram of FIG. 2 schematically shows that liquid crystal substances 321 in the shapes of ellipses are oriented in the same direction. Moreover, the diagram of FIG. 2 schematically shows that liquid crystal substances 321 in the shapes of lines are oriented in various directions.

As shown in FIG. 2, a size of droplet 320 is larger near first transparent body 10 than near second transparent body 20 and the size of droplet 320 near projection-depression structure 13 (indicated as droplet 320c) is almost the same as a size of depression 132. A presence rate of the resin is low near projection-depression structure 13, and thus the resin is less prone to being disposed in depression 132. Droplet 320 fills depression 132. In this way, when the presence rate of the resin is low in depression 132, light distribution performance is enhanced as described below.

A liquid crystal optical element that includes a liquid-crystal-containing resin layer (in particular, a resin layer that contains a polymer-dispersed liquid crystal) can switch between the scattering state and the transparent state according to the application of a voltage. The liquid crystal optical element that changes in optical state in this way is called an active optical element. However, a following problem was found. Assume that a transparent body provided with a projection-depression structure for an optical path change (for light distribution) is applied to such a liquid crystal optical element. In this case, the problem is that a light distribution function cannot be sufficiently obtained because of light scattering at an interface (a projection-depression interface) between the projection-depression structure and the liquid-crystal-containing resin layer. Here, a resin can function as a scatterer that scatters light. This is because the resin divides the liquid crystal into a plurality of small droplets that cause the interface to have a property of scattering light. Thus, when no such scatterer (resin) exists near the projection-depression structure, a wavefront of incident light is deflected according to Huygens' principle and a light distribution direction can be thereby changed by refraction. On this account, even when the liquid-crystal-containing resin layer exists near the projection-depression structure but the droplet size is large, light scattering is unlikely to occur at the projection-depression interface. As a result, unnecessary scattering is prevented from occurring near the projection-depression structure and thus light distribution performance is enhanced.

Light traveling is described in more detail, with reference to FIG. 2. In FIG. 2, only about one droplet 320 exists in depression 132 of projection-depression structure 13. More specifically, the size of droplet 320 is nearly equal to the size of depression 132. Thus, it may be thought that only one mesh of the network structure formed from the resin exists in depression 132. In FIG. 2, a traveling direction of incident light P1 is changed by projection-depression structure 13 and, as a result, incident light P1 is turned into total reflection light P2. At this time, since depression 132 is filled with droplet 320, liquid crystal molecular orientation becomes uniform in depression 132 and scattering is thus reduced. Then, total reflection light P2 enters region which is included in liquid-crystal-containing resin layer 30 and in which the size of droplet 320 is small (that is, a region with a small mesh size). As a result, the light is scattered by the action of the resin (scattered light P3). However, a degree to which the total reflection light is scattered by the resin is low, and the light travels further while maintaining the light distribution performance. Then, scattered light P3 exits to the outside through second transparent body 20.

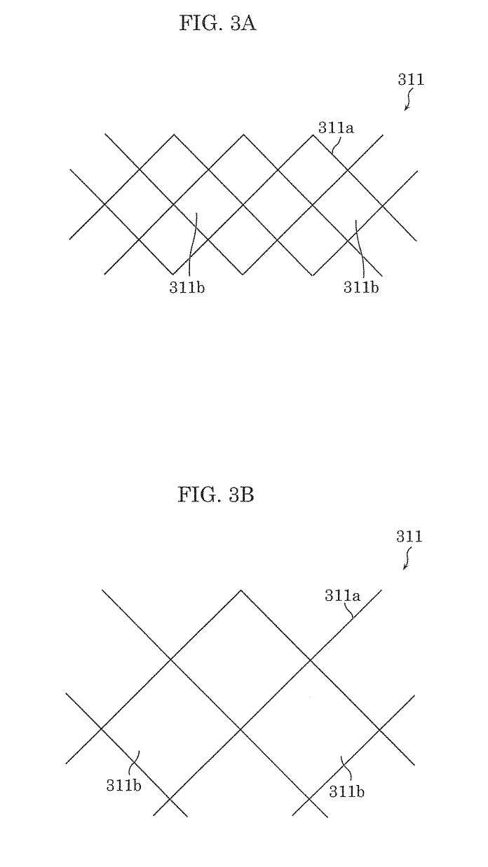

Each of FIG. 3A and FIG. 3B is a diagram showing an example of the network structure formed from the resin (that is, network structure 311). FIG. 3A is a diagram showing network structure 311 near second transparent body 20. FIG. 3B is a diagram showing network structure 311 near first transparent body 10. Network structure 311 includes resin network 311a and a plurality of meshes 311b. Mesh 311b is formed from resin network 811a. Mesh 311b is a space in which no resin exists. The liquid crystal can be disposed in mesh 311b. As shown in FIG. 3A and FIG. 3B, a size of mesh 311b is larger near first transparent body 10 than near second transparent body 20. To be more specific, the size of mesh 311b increases closer to projection-depression structure 13. When the size of mesh 311b increases closer to the projection-depression structure in this way, the resin is less likely to exist in the depression of the projection-depression structure. For this reason, unnecessary scattering is prevented from occurring near the projection-depression structure and thus light distribution performance is enhanced, as with the case described above.

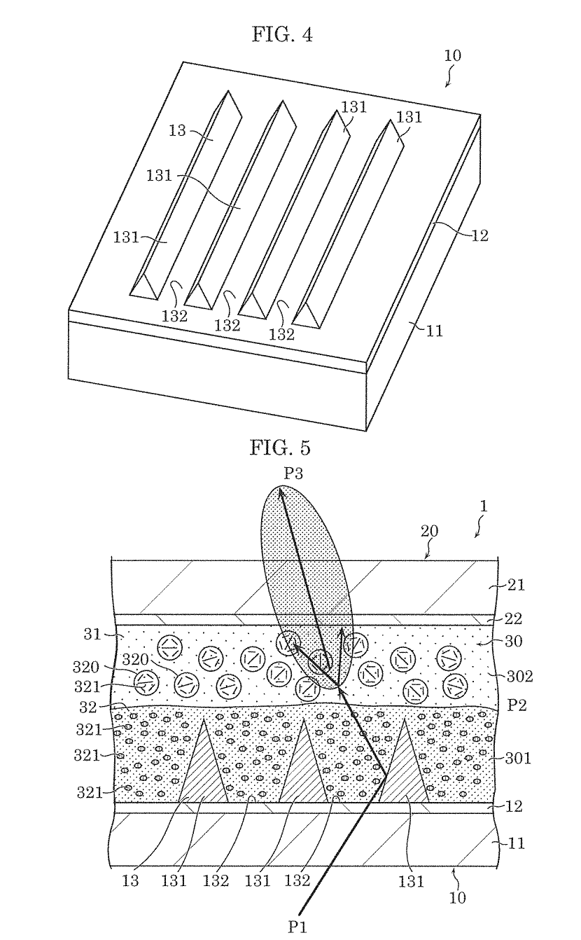

FIG. 4 is a schematic perspective view showing an example of first transparent body 1 of liquid crystal optical element 1. First transparent body 1 includes projection-depression structure 13. The plurality of projections 131 are disposed on a surface of first transparent body 10. The plurality of depressions 132 are disposed on the surface of first transparent body 10. Depression 132 is formed from a space between projections 131 that are adjacent to each other. Projection 131 is linear in shape. Depression 132 is linear in shape. Projection-depression structure 13 shown in FIG. 14 has a stripe pattern. Projection-depression structure 13 has a groove. Depression 132 is a groove. Depression 132 (groove) has a width of 2 μm to 5 μm, for example. Projection 131 has a height of 5 μm to 30 μm, for example. In liquid crystal optical element 1, droplet 320 of liquid crystal is disposed in depression 132. With this, unnecessary scattering caused by intrusion of the resin into the depression is prevented from occurring and thus light distribution performance is enhanced, as described above.

When the size of droplet 320 of liquid crystal increases near the interface of projection-depression structure 13, the liquid crystal molecules can be easily aligned in one direction (a direction along the groove of the projection depression structure) by a shape effect of projection-depression structure 13. This can further reduce scattering at the interface of projection-depression structure 13. It should be noted that the interface of projection-depression structure 13 refers to the interface between first transparent body 10 and liquid-crystal-containing resin layer 30.

Here, it is preferable for a refractive index nₚ of the projection-depression structure to be smaller than an extraordinary-light refractive index nₑ of liquid crystal. In this case, since incident light in a specific range is totally reflected off the interface of projection-depression structure 13, light distribution performance can be enhanced. Outside light enters liquid crystal optical element 1 from first transparent body 10 side, and is totally reflected off the projection-depression interface of projection-depression structure 13. Then, with a change in the travelling direction, this light exits to the outside through second transparent body 20. Here, the extraordinary-light refractive index nₑ refers to a refractive index of an extraordinary ray. An ordinary-light refractive index nₒ refers to a refractive index of an ordinary ray. The liquid crystal of the liquid-crystal-containing resin layer can have the ordinary-light refractive index when a voltage is applied, and have the extraordinary-light refractive index when no voltage is applied. It is preferable for the ordinary-light refractive index of the liquid crystal to be smaller than the extraordinary-light refractive index. It is more preferable for the refractive index nₚ of the projection-depression structure to be nearly equal to the extraordinary-light refractive index nₒ of the liquid crystal.

FIG. 5 is a schematic cross-sectional view showing liquid crystal optical element 1 according to Embodiment 2.

Liquid crystal optical element 1 shown in FIG. 5 is a specific example of liquid crystal optical element 1 in the second mode that is described above and shown in FIG. 1. Structural elements in FIG. 5 that are identical to those described above are given the same reference numerals as above.

As shown in FIG. 5, liquid-crystal-containing resin layer 30 includes the following: first region 301 that contains a liquid crystal and does not contain a resin; and second region 302 that contains both a liquid crystal and a resin. First region 301 is closer to first transparent body 10 than second region 302 is to first transparent body 10. First region 301 and second region 302 are arranged in a thickness direction of the liquid crystal optical element. First region 301 covers projection-depression structure 13. First region 301 covers projection 131. Projection 131 is not in contact with second region 302. In FIG. 2, the resin does not exist near projection-depression structure 13 and is not disposed in depression 132. The liquid crystal fills depression 132. When no resin is disposed in depression 132 in this way, light distribution performance can be enhanced. The reason for this is the same as in the case shown in FIG. 2. More specifically, when no such scatterer (resin) exists near the projection-depression structure, a wavefront of incident light is deflected according to Huygens' principle and a light distribution direction can be thereby changed by refraction. On this account, even when the liquid-crystal-containing resin layer exists near the projection-depression structure but no resin exists, light scattering is unlikely to occur at the projection-depression interface. As a result, unnecessary scattering is prevented from occurring near the projection depression structure and thus light distribution performance is enhanced.

Light traveling is described in more detail, with reference to FIG. 5. In FIG. 5, first region 301 is disposed near projection-depression structure 13. More specifically, depression 132 of projection-depression structure 13 is filled with the liquid crystal. In FIG. 5, a traveling direction of incident light P1 is changed by projection-depression structure 13 and, as a result, incident light P1 is turned into total reflection light P2. At this time, since depression 132 is filled with the liquid crystal, liquid crystal molecular orientation becomes uniform in depression 132 and scattering is thus reduced. Then, total reflection light P2 enters second region 302 of liquid-crystal-containing resin layer 30. As a result, the light is scattered by the action of the resin (scattered light P3). However, a degree to which the total reflection light is scattered by the resin is low, and the light travels further while maintaining the light distribution performance. Then, scattered light P3 exits to the outside through second transparent body 20.

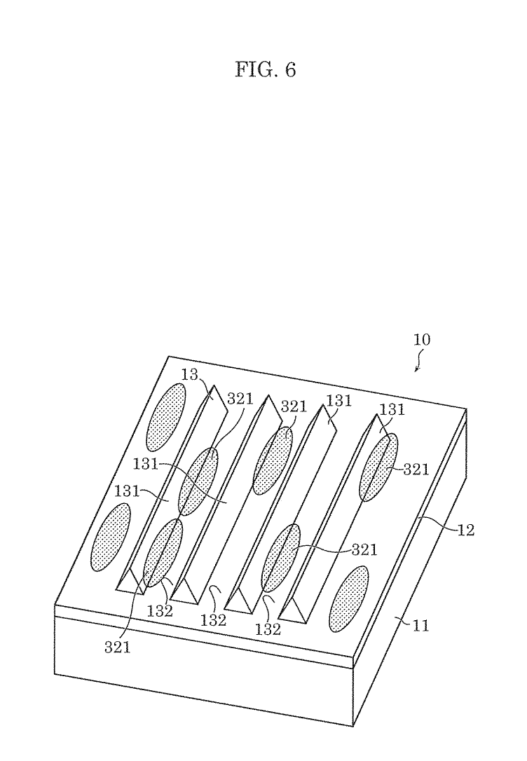

FIG. 6 is a diagram showing an example of liquid crystal orientation to first transparent body 10. In FIG. 6, the diagram schematically shows the liquid crystal orientation. First transparent body 10 has the same structure as first transparent body 10 shown in FIG. 4. In FIG. 6, structural elements that are identical to those described above are given the same reference numerals as above. Liquid crystal substance 321 is illustrated as a slender ellipse. Liquid crystal substance 321 is disposed along a direction in which the groove of depression 132 extends. A longitudinal direction of liquid crystal substance 321 is the same as the direction in which the groove extends. Moreover, a plurality of liquid crystal substances 321 are oriented in the same direction. In this way, when depression 132 is formed in the shape of a groove, the orientations of the liquid crystal substances can be easily aligned. This is because liquid crystal substance 321 has a slender shape and the longitudinal direction of this slender shape can be easily aligned with a longitudinal direction of the groove. When liquid crystal substances 321 are oriented in the same direction, light is less likely to be scattered. Thus, light scattering at the interface of projection-depression structure 13 is further reduced, and light distribution performance of liquid crystal optical element 1 can be enhanced.

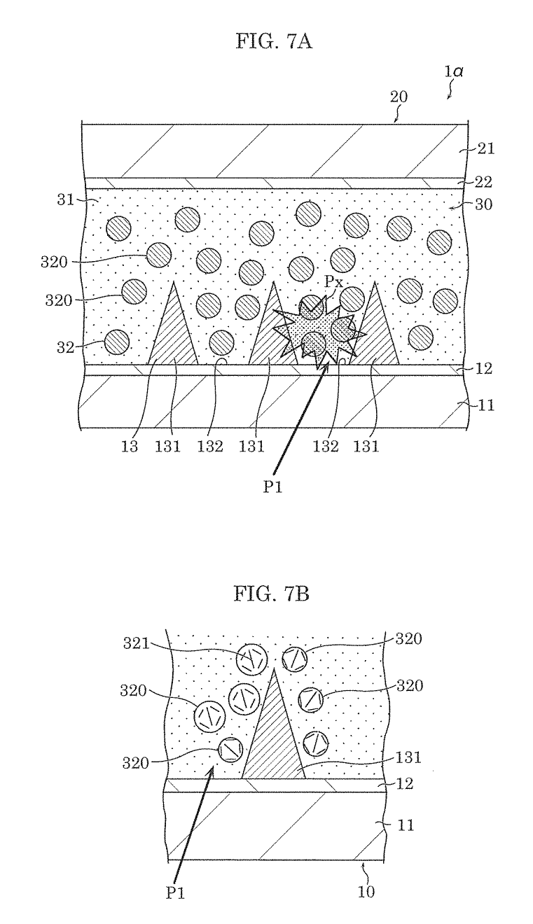

Each of FIG. 7A and FIG. 7B is a schematic diagram showing liquid crystal optical element 1a that is a comparative example of liquid crystal optical element 1 according to Embodiment 1 and Embodiment 2 above. FIG. 7A is a schematic diagram showing the whole of liquid crystal optical element 1a FIG. 7B is a schematic diagram showing a region near projection-depression structure 13. Structural elements that are identical to (or that correspond to) those described in Embodiment 1 and Embodiment 2 above are given the same reference numerals as in Embodiment 1 and Embodiment 2.

Liquid crystal optical element 1a has the same configuration as in Embodiment 1 and Embodiment 2 described above, except for a structure of liquid-crystal-containing resin layer 30. All droplets 320 in liquid-crystal-containing resin layer 30 of liquid crystal optical element 1a have the same size. The size of droplet 320 is smaller than a width of depression 132. A plurality of droplets 320 are disposed in depression 132. On this account, a resin exists in depression 132. In this way, the resin and the plurality of droplet 320 exist in spaces of projection-depression structure 13. It should be noted that the element disclosed in PTL 1 (Japanese Unexamined Patent Application Publication No. 2005-250055) includes the droplets that have the same size.

When incident light P1 enters liquid crystal optical element 1a, the light is scattered at interfaces between the resin and the plurality of droplets present in the spaces of projection-depression structure 13. Scattered light Px thus becomes directionless and travels in a wide direction. For this reason, light distribution by projection-depression structure 13 does not function any longer. This is because the light scattering occurring near projection-depression structure 13 does not allow a waveform to be formed and thus results in no refraction nor total reflection of light.

As can be understood from the comparison with liquid crystal optical element 1a, liquid crystal optical element 1 according to Embodiment 1 and Embodiment 2 is less likely to cause light scattering that results from the interfaces between the resin and the droplets near projection-depression structure 13. Hence, liquid crystal optical element 1 having high light distribution performance can be obtained.

Here, droplet 320 has a diameter of 1 μm to 2 μm, for example. With such a small diameter, light (outside light) entering liquid crystal optical element 1 causes Mie scattering and may be brought into a cloudy state. To perform light distribution control on the outside light by projection-depression structure 13, a refractive index difference at the interface of projection-depression structure 13 needs to be controlled by a voltage so that an orientation direction of the light can be changed. Here, this change in light distribution is determined according to Snell's law and, to achieve this, a wavefront needs to be formed according to Huygens' principle. However, when a resin scatterer exists near the interface of projection-depression structure 13 as in liquid crystal optical element 1a, the wavefront is not formed and a change in light distribution is thereby less likely to occur. On the other hand, no resin scatterer exists near projection-depression structure 13 in liquid crystal optical element 1 according to Embodiment 1 and Embodiment 2 described above. Thus, the wavefront is formed and the change in light distribution thereby occurs. For example, the size of droplet 320 increases to about 3 μm to 5 μm near projection-depression structure 13.

Liquid crystal optical element 1 is formed from an appropriate material. For the material of first transparent substrate 11, glass or resin may be used for example. For the material of second transparent substrate 21, glass or resin may be used for example. For the material of first transparent electrode 12, a transparent metal oxide (such as indium tin oxide [ITO]) may be used for example. For the material of second transparent electrode 22, a transparent metal oxide (such as ITO) may be used for example. For the material of projection-depression structure 13, a resin may be used for example. It is preferable for projection-depression structure 13 to be formed from an acrylic resin. Projection-depression structure 13 may include an electrically conductive material. For the material of liquid-crystal-containing resin layer 30, a polymer-dispersed, liquid crystal may be used for example. Note that the materials of liquid crystal optical element 1 are not limited to these examples.

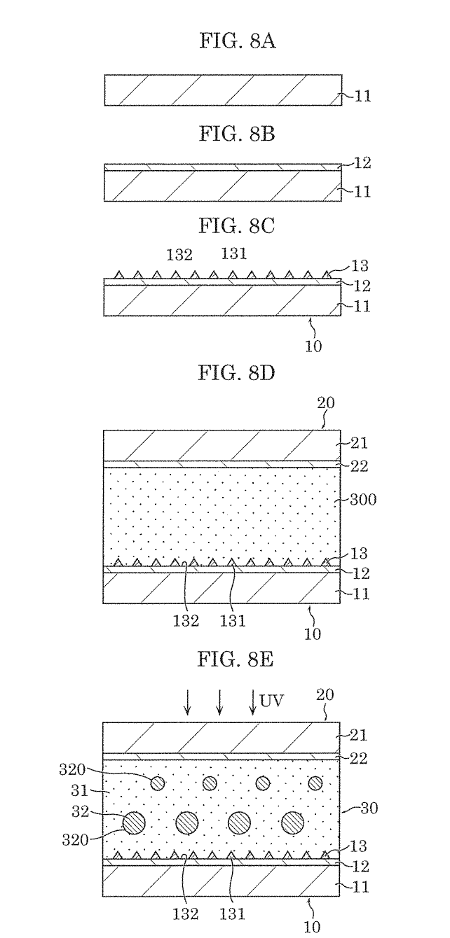

Hereinafter, a method for manufacturing liquid crystal optical element 1 is described. FIG. 8A to FIG. 8E are cross-sectional views respectively showing first to fifth processes of the method for manufacturing liquid crystal optical element 1.

Firstly, as shown in FIG. 8A, first transparent substrate 11 is prepared (the first process).

Next, as shown in FIG. 8B, first transparent electrode 12 is formed on first transparent substrate 11 (the second process). First transparent electrode 12 is formed by a method selected from among, for example, vapor deposition, sputtering, and coating.

Next, as shown in FIG. 8C, projection-depression structure 13 is formed on first transparent electrode 12 (the third process). Projection-depression structure 13 is formed as follows, for example. A resin layer is firstly formed, and then a mold (a molding die) having projections and depressions is pressed against the resin layer to allow these projections and depressions to be transferred onto the resin layer. As a result, projection-depression structure 13 is formed as the resin layer having the projections and depressions. The resin layer can be formed by a coating method. It should be noted that the resin layer be split up at depressions 132 of projection-depression structure 13 or may be one continuous layer. By forming projection-depression structure 13, first transparent body 10 is formed.

Furthermore, second transparent body 20 is formed separately from first transparent body 10. Second transparent body 20 is formed by forming second transparent electrode 22 on second transparent substrate 21. The laminated, structure shown in FIG. 8B can be thought to have the same structure as second transparent body 20.

Next, as shown in FIG. 8D, first transparent body 10 and second transparent body 20 are disposed opposite to each other, and resin composition 300 is interposed between first transparent body 10 and second transparent body 20 (the fourth process). Resin composition 300 is a material used for forming liquid-crystal-containing resin layer 30. Resin composition 300 contains at least, a liquid crystal material and an ultraviolet curable resin. The ultraviolet curable resin may contain a monomer. Resin composition 300 may be disposed on first transparent body 10 by, for example, the coating method, or may be injected into a space between first transparent body 10 and second transparent body 20. By disposing resin composition 300 in this way a layer of resin position 300 is formed.

It should be noted that a sealing resin surrounding the space between, first transparent body 10 and second transparent body 20 may be interposed between first transparent body 10 and second transparent body 20. The sealing resin has a function of bonding first transparent body 10 and second transparent body 20 together and a function of leaving a space between first transparent body 10 and second transparent body 20. Moreover, in the case where resin composition 300 is injected, the sealing resin has a function of keeping resin composition 300 from spilling. The sealing resin functions as a wall. The liquid crystal optical element may include the sealing resin.

Then, as shown in FIG. 8E, after a laminated structure that includes first transparent body 10, the layer of resin composition 300, and second transparent body 20 is formed, resin composition 300 is irradiated with ultraviolet (UV) light through second transparent body 20 (the fifth process). A resin component of resin composition 300 is cured by ultraviolet light. By curing the ultraviolet curable resin in this way, liquid-crystal-containing resin layer 30 is formed. Resin portion 31 is formed from the ultraviolet curable resin. Liquid crystal portion 32 is formed from the liquid crystal material. The cured resin forms a resin network structure which causes the liquid crystal material to be divided into the plurality of droplets 320. In this way, liquid crystal optical element 1 shown in FIG. 1 is obtained.

As described above, the method for manufacturing the liquid crystal optical element according to the present disclosure includes: the process of forming first transparent body 10; the process of forming second transparent body 20; the process of disposing resin composition 300; and the process of irradiating resin composition 300 with ultraviolet light through second transparent body 20. In the process of disposing resin composition 300, resin composition 300 is interposed between first transparent body 10 and second transparent body 20. Resin composition 300 contains at least the liquid crystal material and the ultraviolet curable resin.

Here, to describe the method for forming liquid crystal optical element 1 according to Embodiment 1 and Embodiment 2 above, attention is focused on the method for forming liquid-crystal-containing resin layer 30. The size of droplet 320 in liquid-crystal-containing resin layer 30 (in particular, the resin layer that contains the polymer-dispersed liquid crystal) is determined by a polymerization rate of the resin and a mixing ratio between the resin and the liquid crystal. In view of a drive voltage and a transmittance, a material containing a great amount of liquid crystal and thus having at least 70 mass % as the liquid crystal fraction in the mixing ratio is adopted. For example, a composition of resin composition 300 contains 70 mass % to 95 mass % of the liquid crystal material and 5 mass % to 30 mass % of the ultraviolet curable resin. In addition, when a polymerization initiator is included, this composition contains 0.01 mass % to 5 mass % of the polymerization initiator. In the case where this material has a slow polymerization rate, the sizes of droplets 320 are not uniform. The reason for this is as follows. The slow polymerization rate firstly causes phase separation of the resin and the liquid crystal in a region in, which polymerization starts earlier, and thus the resin having the small volume ratio is consumed in the polymerized region. As a result of this, a percentage of resin content decreases in a region in which polymerization does not occur while a percentage of liquid crystal content increases in a region in which polymerization is to occur. Thus, to increase the size of droplet 320 near projection-depression structure 13, a method may be adopted that causes phase separation near projection-depression structure 13 to start at a later time than phase separation of the other regions.

On the basis of the idea described above, one of the following methods can be adopted to form liquid-crystal-containing resin layer 30 that is desired.

By a first method, resin composition 300 contains a liquid crystal material, an ultraviolet curable resin, a polymerization initiator, and an ultraviolet absorber. In this case, when ultraviolet light is irradiated from second transparent body 20 side, the ultraviolet light is absorbed by the ultraviolet absorber and thus the intensity of the ultraviolet light decreases toward first transparent body 10 side. More specifically, phase separation near projection-depression structure 13 is caused to start at a later time, a structure is obtained in which the diameter of droplet 320 is larger near projection-depression structure 13. In this way liquid crystal optical element 1 according to Embodiment 1 is obtained. Furthermore, when droplets 320 increase in diameter to be connected together near projection-depression structure 13 to fill projection-depression structure 13, liquid crystal optical element 1 according to Embodiment 2 is obtained.

By a second method, resin composition 300 contains a liquid crystal material, an ultraviolet curable resin, and a polymerization initiator. Moreover, a volume ratio of the polymerization initiator in resin composition 300 is 0.3% or less. In this case, when ultraviolet light is irradiated from second transparent body 20 side, the polymerization initiator is consumed near second transparent body 20 and thus the amount of polymerization initiator decreases toward first transparent body 10 side because the amount of polymerization initiator is initially small. More specifically, phase separation near projection-depression structure 13 is caused to start at a later time, a structure is obtained in which the diameter of droplet 320 is larger near projection-depression structure 13. In this way, liquid crystal optical element 1 according to Embodiment 1 is obtained. Furthermore, when droplets 320 increase in diameter to be connected together near projection-depression structure 13 to fill projection-depression structure 13, liquid crystal optical element 1 according to Embodiment 2 is obtained.

By a third method, the manufacturing method further includes a process of thrilling, on second transparent body 20, a layer that contains a polymerization initiator. Resin composition 300 may not contain a polymerization initiator. The layer that contains the polymerization initiator is defined as a polymerization initiating layer. The polymerization initiating layer is formed on second transparent electrode 22. The polymerization initiating layer is interposed between second transparent electrode 22 and liquid-crystal-containing resin layer 30. The polymerization initiating layer is formed before first transparent body 10 and second transparent body 20 are disposed opposite to each other. When the polymerization initiating layer is present and ultraviolet light is irradiated from second transparent body 20 side, polymerization progresses near second transparent body 20 by the action of the polymerization initiating layer and phase separation thereby starts near second transparent body 20. More specifically, phase separation near projection-depression structure 13 is caused to start at a later time, a structure is obtained in which the diameter of droplet 320 is larger near projection-depression structure 13. In this way, liquid crystal optical element 1 according to Embodiment 1 is obtained. Furthermore, when droplets 320 increase in diameter to be connected together near projection-depression structure 13 to fill projection-depression structure 13, liquid crystal optical element 1 according to Embodiment 2 is obtained.

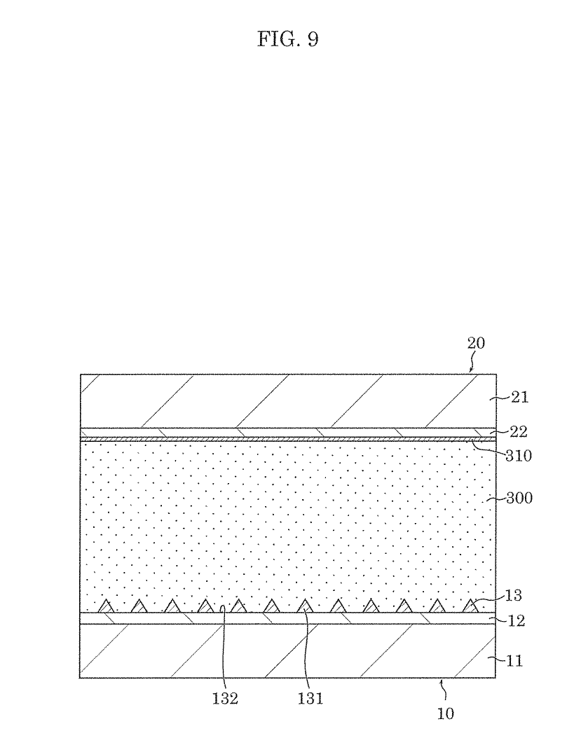

FIG. 9 is a cross-sectional view that shows an example of a method for manufacturing liquid crystal optical element 1 when the third method is applied and that illustrates liquid crystal optical element 1 in progress. In FIG. 9, polymerization initiating layer 310 (the layer that contains the polymerization initiator) is interposed between the layer of resin composition 300 and second transparent electrode 22. Polymerization initiating layer 310 is bonded to second transparent body 20. When ultraviolet light is irradiated, polymerization progresses from near polymerization initiating layer 310. After the end of ultraviolet light irradiation, liquid crystal optical element 1 shown in FIG. 1 is obtained. In liquid crystal optical element 1, polymerization initiating layer 310 may remain, or may not remain by being consumed by polymerization.

When the third method is applied, it is preferable for the layer containing the polymerization initiator (the polymerization initiating layer) to contain a silane coupling agent. The silane coupling agent can increase adhesion of the polymerization initiating layer and thus can make it hard for the polymerization initiating layer to come off second transparent body 20.

By a fourth method, resin composition 300 contains a liquid crystal material, an ultraviolet curable resin, and a polymerization initiator. Here, the polymerization initiator is immiscible with the ultraviolet curable resin. Moreover, the layer of resin composition 300 before the ultraviolet light irradiation has: a region that is closer to second transparent body 20 and contains the polymerization initiator; and a region that is closer to first transparent body 10 and contains a resin and a liquid crystal. In this case, as with the case where the polymerization initiating layer is present, when ultraviolet light is irradiated from second transparent body 20 side, polymerization progresses near second transparent body 20 by the action of the polymerization initiating layer and phase separation thereby starts near second transparent body 20. More specifically, phase separation near projection-depression structure 13 is caused to start at a later time, a structure is obtained in which the diameter of droplet 320 is larger near projection-depression structure 13. In this way, liquid crystal optical element 1 according to Embodiment 1 is obtained. Furthermore, when droplets 320 increase in diameter to be connected together near projection-depression structure 13 to fill projection-depression structure 13, liquid crystal optical element 1 according to Embodiment 2 is obtained.

By a fifth method, resin composition 300 contains a liquid crystal material, an ultraviolet curable resin, a polymerization initiator, and a radical trapping agent. In this case, when ultraviolet light is irradiated from second transparent body 20 side, radicals occurring at the time of ultraviolet polymerization are trapped by the radical trapping agent. Thus, obtainment of a high polymer resin resulting from polymerization is delayed, and phase separation resulting from the polymerization is also delayed. More specifically phase separation near projection-depression structure 13 is caused to start at a later time, a structure is obtained in which the diameter of droplet 320 is larger near projection-depression structure 13. In this way, liquid crystal optical element 1 according to Embodiment 1 is obtained. Furthermore, when droplets 320 increase in diameter to be connected together near projection-depression structure 13 to fill projection-depression structure 13, liquid crystal optical element 1 according to Embodiment 2 is obtained.

Hereinafter, application of liquid crystal optical element 1 is described. Liquid crystal optical element 1 can be used for, for example, a window or a partition. The window may be used for a building or a vehicle (such as a car).

The traveling direction of light that passes through liquid crystal optical element 1 can possibly change. For example, when liquid crystal optical element 1 is used as a window of a house, incident, light from the sun changes into light that travels toward a ceiling inside a room by the action of liquid crystal optical element 1. To be more specific, the incident light from the sun is distributed, and a direction of light traveling downward is changed into an upward direction. In this case, sunlight can be brought into the room efficiently and thus brightens the inside of the room. Thus, a power saving can be achieved by turning off a room light or lowering an illumination level of the room light. Here, in the case where liquid crystal optical element 1 is of a passive type and thus has only a constant light distribution property, an optical path changes even when a user views the outdoors from the inside of the room. On this account, transparency of, for example, a window glass cannot be obtained. On the other hand, liquid crystal optical element 1 according to the present disclosure is of an active type and thus can switch between a transparent state and a light distribution state according to whether a voltage is applied or not. With this, the state can be changed between the transparent state and the light distribution state depending on the purpose. Thus, the number of applications of liquid crystal optical element 1 can be increased. Furthermore, liquid crystal optical element 1 according to the present disclosure can be provided with a moderate scattering state by liquid-crystal-containing resin layer 30. This moderate scattering state can prevent the outside light from being directly looked at and, therefore, can reduce glare. In this way, liquid crystal optical element 1 can switch between the transparent state and the light distribution state, and can cause moderate scattered light. Thus, liquid crystal optical element 1 is optically excellent.

### EXAMPLE 1

A liquid crystal optical element was manufactured by a method described below.

Firstly, an ITO (first transparent electrode 12) having a thickness of 100 nm was formed on a glass substrate (first transparent substrate 11). Next, a resin layer was formed by applying a coating of an acrylic resin (with a refractive index of 1.5) on the ITO. Then, by pressing a mold against this resin layer, projection-depression structure 13 that was a triangle in cross section was formed. Projection-depression structure 13 had a stripe pattern in which linear projections were spaced at regular intervals. Each projection had a height of 10 μm, and a length of the space between the projections (a width of a depression) was 4 μm. The resin layer was cured by ultraviolet irradiation. As a result, first transparent body 10 was obtained.

In the same manner as above, an ITO (second transistor electrode 22) having a thickness of 100 nm was formed on a glass substrate (second transistor substrate 21). As a result, second transparent body 20 was obtained.

First transparent body 10 and second transparent body 20 described above were disposed opposite to each other. Then, a sealing resin was used to seal around first transparent body 10 and second transparent body 20, and a space was formed between first transparent body 10 and second transparent body 20. Next, resin composition 300 was injected into this space to form liquid-crystal-containing resin layer 30 (a polymer-dispersed liquid crystal layer, in this example). Here, resin composition 300 was injected by a vacuum injection method. Resin composition 300 contained a liquid crystal material, an ultraviolet curable resin, a polymerization initiator, and an ultraviolet absorber. The composition of resin composition 300 included 85 mass % of the liquid crystal material, 13 mass % of the ultraviolet curable resin, 1 mass % of the polymerization initiator, and 1 mass % of the ultraviolet absorber. The components of resin composition 300 were miscible with each other. An ordinary-light refractive index (nₒ) of the liquid crystal was 1.5, and an extraordinary-light refractive index (nₑ) of the liquid crystal was 1.7. Furthermore, the ultraviolet absorber that absorbed light having a wavelength of 380 nm or less was used. As a result, a laminated structure in which first transparent body 10, the layer of resin composition 300, and second transparent body 20 were laminated was obtained.

The laminated structure described above was irradiated with ultraviolet light from second transparent body 20 side at a temperature of 20° C. As a result of this, a polymer-dispersed liquid crystal layer was formed from the layer of resin composition 300. In this way, liquid crystal optical element 1 according to Example 1 was obtained.

A cross-section structure of liquid crystal optical element 1 according to Example 1 was observed using a scanning electron microscope (SEM). As a result of the observation, one droplet 320 was disposed in the depression of projection-depression structure 13 and the diameter of droplet 320 was 3.8 μm. Moreover, the size of droplet 320 near second transparent body 20 was 1.5 μm.

The light distribution performance of liquid crystal optical element 1 according to Example 1 was evaluated by applying a voltage or applying no voltage (by switching between ON and OFF). Firstly, a voltage of 20 V was applied to liquid crystal optical element 1 (i.e., liquid crystal optical element 1 was turned ON). In this case, the liquid crystal rose in a direction perpendicular to the substrate, and the refractive indexes of projection-depression structure 13 and liquid-crystal-containing resin layer 30 matched with each other. As a result, liquid crystal optical element 1 became transparent. The optical transmittance of liquid crystal optical element 1 at this time was 80%. On the other hand, no voltage was applied to liquid crystal optical element 1 (i.e., liquid crystal optical element 1 was turned OFF). In this case, 15% of the incident light was emitted in a direction different from the straight traveling direction. As a result, the light distribution performance of liquid crystal optical element 1 was exerted.

### EXAMPLE 2

Liquid crystal optical element 1 was manufactured in the same manner as in Example 1. However, a composition of resin composition 300 according to Example 2 was different from the composition according to Example 1. The composition of resin composition 30 according to Example 2 included 90 mass % of the liquid crystal material, 7 mass % of the ultraviolet curable resin, 0.7 mass % of the polymerization initiator, and 2.3 mass % of the ultraviolet absorber. Except for this composition, liquid crystal optical element 1 according to Example 2 was obtained in the same manner as in Example 1.

A cross-section structure of liquid crystal optical element 1 according to Example 2 was observed using a SEM. As a result of the observation, a region. (first region 301) in which the liquid crystal existed and the resin did not exist was formed near projection-depression structure 13 in liquid-crystal-containing resin layer 30. Furthermore, a region (second region 302) in which both the crystal and the resin existed was formed between first region 301 and second transparent body 20. It is believed that the amount of ultraviolet light reaching near projection-depression structure 13 was significantly reduced since the amount of ultraviolet absorber in Example 2 was larger than that in Example 2. Furthermore, when the ultraviolet curable resin was polymerized according to Example 2, the resin was precipitated by phase separation near second transparent body 20 and thus was consumed. It is believed that this was the reason that first region 301 in which only the liquid crystal existed was formed near projection-depression structure 13.

The light distribution performance of liquid crystal optical element 1 according to Example 2 was evaluated by applying a voltage or applying no voltage (by switching between ON and OFF). Firstly, a voltage of 20 V was applied to liquid crystal optical element 1 (i.e., liquid crystal optical element 1 was turned ON). In this case, the liquid crystal rose in a direction perpendicular to the substrate, and the refractive indexes of projection-depression structure 13 and liquid-crystal-containing resin layer 30 matched with each other. As a result, liquid crystal optical element 1 became transparent. The optical transmittance of liquid crystal optical element 1 at this time was 80%. On the other hand, no voltage was applied to liquid crystal optical element 1 (i.e., liquid crystal optical element 1 was turned OFF). In this case, 20% of the incident light was emitted in a direction different from the straight traveling direction. As a result, the light distribution performance of liquid crystal optical element 1 was exerted.

The liquid crystal optical element according to the present disclosure has been described on the basis of the embodiments and examples thus far. However, the present disclosure, is not limited to the embodiment and examples described above.

For example, other embodiments implemented through various changes and modifications conceived by a person of ordinary skill in the art based on the above embodiments and examples or through a combination of the structural elements and functions in the above embodiments and examples unless such combination departs from the scope of the present disclosure may be included in the scope in an aspect or aspects according to the present disclosure.

### REFERENCE MARKS IN THE DRAWINGS

1 liquid crystal optical element

10 first transparent body

11 first transparent substrate

12 first transparent electrode

13 projection-depression structure

20 second transparent body

21 second transparent substrate

22 second transparent electrode

30 liquid-crystal-containing resin layer

132 depression

300 resin composition

301 first region

309 second region

311 network structure

311b mesh

320 droplet

1. A liquid crystal optical element comprising:
a first transparent body which includes a first transparent substrate, a first transparent electrode, and a projection-depression structure;
a second transparent body which is disposed opposite to the first transparent body, and includes a second transparent substrate and a second transparent electrode that is electrically paired with the first transparent electrode; and
a liquid-crystal-containing resin layer which is interposed between the first transparent body and the second transparent body and contains a liquid crystal and a resin,
wherein the liquid-crystal-containing resin layer has at least one of a droplet structure formed from the liquid crystal and a network structure formed from the resin, and
at least one of a size of a droplet of the droplet structure and a size of a mesh of the network structure is larger near the first transparent body than near the second transparent body.

2. The liquid crystal optical element according to claim 1,
wherein, near the first transparent body, at least one of the droplet of the droplet structure and the mesh of the network structure has a size that corresponds to a width of a depression of the projection-depression structure.

3. The liquid crystal optical element according to claim 1,
wherein the liquid-crystal-containing resin layer contains a dichroic dye.

4. A liquid crystal optical element comprising:
a first transparent body which includes a first transparent substrate, a first transparent electrode, and a projection-depression structure;
a second transparent body which is disposed opposite to the first transparent body, and includes a second transparent substrate and a second transparent electrode that is electrically paired with the first transparent electrode; and
a liquid-crystal-containing resin layer which is interposed between the first transparent body and the second transparent body and contains a liquid crystal and a resin,
wherein the liquid-crystal-containing resin layer has: a first region that contains the liquid crystal and does not contain the resin; and a second region that contains both the liquid crystal and the resin, and
the first region is closer to the first transparent body than the second region is to the first transparent body, and covers the projection-depression structure.

5. A method for manufacturing the liquid crystal optical element according to claim 1, the method comprising:
forming the first transparent body;
foaming the second transparent body;
interposing, between the first transparent body and the second transparent body, a resin composition that contains a liquid crystal material, an ultraviolet curable resin, a polymerization initiator, and an ultraviolet absorber; and
irradiating the resin composition with ultraviolet light through the second transparent body.

6. A method for manufacturing the liquid crystal optical element according to claim 1, the method comprising:
forming the first transparent body;
forming the second transparent body;
interposing, between the first transparent body and the second transparent body, a resin composition that contains a liquid crystal material, an ultraviolet curable resin, and a polymerization initiator; and
irradiating the resin composition with ultraviolet light through the second transparent body,
wherein a volume ratio of the polymerization initiator in the resin composition is 0.3% or less.

7. A method for manufacturing the liquid crystal optical element according to claim 1, the method comprising:
forming the first transparent body;
forming the second transparent body;
forming, on the second transparent body, a layer that contains a polymerization initiator;
interposing, between the first transparent body and the second transparent body, a resin composition that contains a liquid crystal material and an ultraviolet curable resin; and
irradiating the resin composition with ultraviolet light through the second transparent body.

8. The method for manufacturing the liquid crystal optical element according to claim 7,
wherein the layer containing the polymerization initiator contains a silane coupling agent.

9. A method for manufacturing the liquid crystal optical element according to claim 1, the method comprising:
forming the first transparent body;
forming the second transparent body;
interposing, between the first transparent body and the second transparent body, a resin composition that contains a liquid crystal material, an ultraviolet curable resin, and a polymerization initiator; and
irradiating the resin composition with ultraviolet light through the second transparent body,
wherein the polymerization initiator is immiscible with the ultraviolet curable resin, and
before the irradiating, the resin composition forms a layer that has: a region that is closer to the second transparent body and includes the polymerization initiator; and a region that is closer to the first transparent body and includes the resin and the liquid crystal.

10. A method for manufacturing the liquid crystal optical element according to claim 1, the method comprising:
forming the first transparent body;
forming the second transparent body;
interposing, between the first transparent body and the second transparent body, a resin composition that contains a liquid crystal material, an ultraviolet curable resin, a polymerization initiator, and a radical trapping agent; and
irradiating the resin composition with ultraviolet light through the second transparent body.
